(19) United States
(12) Patent Application Publication
(10) Pub. No.: US 2014/0005886 A1
(43) Pub. Date: Jan. 2, 2014

(54) CONTROLLING AUTOMOTIVE FUNCTIONALITY USING INTERNAL- AND EXTERNAL-FACING SENSORS

(71) Applicants: Daniel Scott Morris, Bellevue, WA (US); Hrvoje Benko, Seattle, WA (US); Jay P. Kapur, Redmond, WA (US); Andrew David Wilson, Seattle, WA (US); Kenneth Alan Lobb, Sammamish, WA (US)

(72) Inventors: Daniel Scott Morris, Bellevue, WA (US); Hrvoje Benko, Seattle, WA (US); Jay P. Kapur, Redmond, WA (US); Andrew David Wilson, Seattle, WA (US); Kenneth Alan Lobb, Sammamish, WA (US)

(73) Assignee: MICROSOFT CORPORATION, Redmond, WA (US)

(21) Appl. No.: 13/539,264

(22) Filed: Jun. 29, 2012

(51) Int. Cl. G06F 7/00

(52) U.S. Cl. 701/36

(57) ABSTRACT

Embodiments are directed to automotive systems including automotive alerting systems and automotive heads-up display projection systems. In one case, an automotive system includes an internal-facing sensor and an external-facing sensor positioned within an automobile. The automotive system further includes an information processing system that performs various items including receiving interior sensor input from the internal-facing sensor and from the external-facing sensor. The interior sensor input indicates information about the actions the driver and any other automobile occupants. The exterior sensor indicates information about objects that are external to the automobile. The information processing system then determines, based on both the interior sensor input and the exterior sensor input, an appropriate action to perform and performs that action. Such actions may include increasing or decreasing the salience of a triggered alert.

### BACKGROUND

Computers have become highly integrated in the workforce, in the home, in mobile devices, and many other places. For instance, computers have become an integral part of modern automobiles. Computers or other programmable logic devices control many aspects of automotive functionality including engine timing, gear shifting, shock absorption, navigation, climate controls and many others. Such control over this automotive functionality allows vehicles to perform more efficiently in all different types of conditions.

In some cases, these automotive computers are designed to work with sensors such as air flow sensors, temperature sensors, speed sensors, tire pressure sensors or other sensors to make decisions about how to control the automobile's various types of functionality. These sensors feed data to a processor and that processor determines how to control the automotive devices based on the received data. External-facing cameras have been used in automobiles to provide information about objects exterior to the car (such as detecting nearby cars or potential hazards). Internal-facing cameras have been used to detect the number of occupants in a car or, for example, to detect when a driver is becoming drowsy. As such, various forms of input can be used to control a vehicle's functionality.

### BRIEF SUMMARY

Embodiments described herein are directed to various automotive systems including automotive alerting systems and automotive heads-up display projection systems. In one embodiment, an automotive system includes an internal-facing sensor and an external-facing sensor positioned within an automobile. The automotive system also includes an information processing system that performs various items including receiving interior sensor input from the internal-facing sensor and from the external-facing sensor. The interior sensor input indicates information about the actions the driver and any other automobile occupants. The exterior sensor indicates information about various objects that are external to the automobile. The information processing system then determines, based on both the interior sensor input and the exterior sensor input, an appropriate action to perform and performs that action.

In one embodiment, a method for providing appropriate automotive alerts is provided. The method includes receiving interior sensor input from an internal-facing sensor and exterior sensor input from an external-facing sensor. As above, the interior sensor input indicates information about the actions of the driver and any other automobile occupants. The exterior sensor input indicates information about various objects that are external to the automobile. The method then includes determining, based on both the received interior sensor input and the received exterior sensor input, that the driver was looking in a specified direction when an object external to the automobile triggered an alert. Then, based on the direction the driver was looking and based on the location of the external object, the method determines an appropriate alerting action to perform and performs the determined alerting action.

In yet another embodiment, an automotive heads-up display projection system is provided. The system includes an internal-facing sensor and an external-facing sensor positioned within an automobile. The system also includes an internal heads-up display projector that projects a heads-up display on various interior surfaces of the automobile. Still further, the system includes an information processing system that performs the following: receives interior sensor input from the internal-facing sensor and from the external-facing sensor, determines, based on both the interior sensor input and the exterior sensor input, an appropriate action to perform and performs that action.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates an automotive system that performs determined functions based on interior and exterior sensor input.

FIG. 2 illustrates an embodiment in which automotive alerts are sent from one vehicle to another vehicle based on feedback from internal and external sensors.

FIG. 3 illustrates an embodiment of a heads-up display projector that projects annotations based on interior and exterior sensor input.

FIG. 4 illustrates a flowchart of an example method for providing appropriate automotive alerts to a driver based on interior and exterior sensor input.

### DETAILED DESCRIPTION

Embodiments described herein are directed to various automotive systems including automotive alerting systems and automotive heads-up display projection systems. In one embodiment, an automotive system includes an internal-facing sensor and an external-facing sensor positioned within an automobile. The automotive system also includes an information processing system that performs various items including receiving interior sensor input from the internal-facing sensor and from the external-facing sensor. The interior sensor input indicates information about the actions the driver and any other automobile occupants. The exterior sensor indicates information about various objects that are external to the automobile. The information processing system then determines, based on both the interior sensor input and the exterior sensor input, an appropriate action to perform and performs that action.

In one embodiment, a method for providing appropriate automotive alerts is provided. The method includes receiving interior sensor input from an internal-facing sensor and exterior sensor input from an external-facing sensor. As above, the interior sensor input indicates information about the actions of the driver and any other automobile occupants. The exterior sensor input indicates information about various objects that are external to the automobile. The method then includes determining, based on both the received interior sensor input and the received exterior sensor input, that the driver was looking in a specified direction when an object external to the automobile triggered an alert. Then, based on the direction the driver was looking and based on the location of the external object, the method determines an appropriate alerting action to perform and performs the determined alerting action.

In yet another embodiment, an automotive heads-up display projection system is provided. The system includes an internal-facing sensor and an external-facing sensor positioned within an automobile. The system also includes an internal heads-up display projector that projects a heads-up display on various interior surfaces of the automobile. Still further, the system includes an information processing system that performs the following: receives interior sensor input from the internal-facing sensor and from the external-facing sensor, determines, based on both the interior sensor input and the exterior sensor input, an appropriate action to perform and performs that action.

The following discussion now refers to systems, methods and computer program products that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein including automotive alerting systems and automotive heads-up display projection systems may implement a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer (internal to or external to an automobile), the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations interior-to or exterior-to an automobile, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

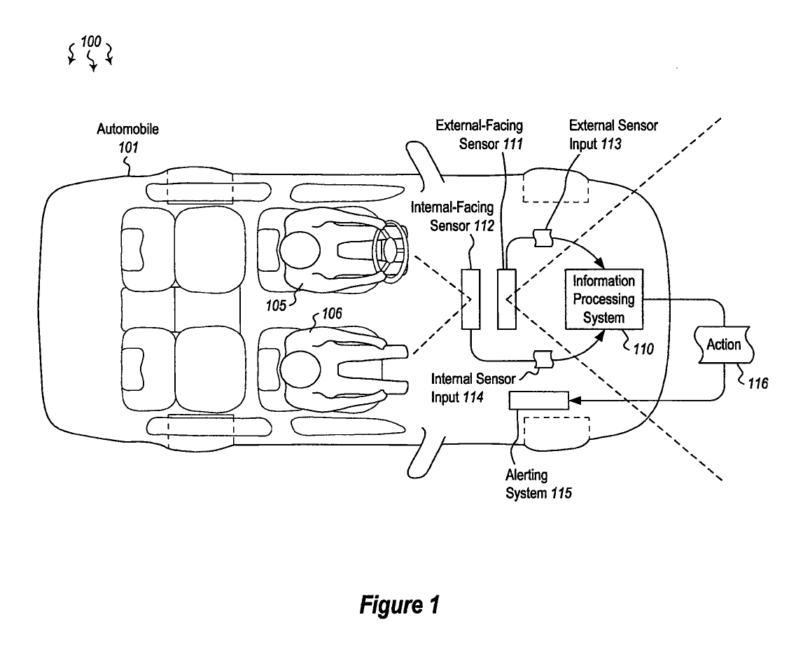

FIG. 1 illustrates an automotive system 100 in which different embodiments may be employed. The automotive system includes automobile 101. The automobile may be any type of car, truck, van or other type of vehicle. The vehicle includes a driver 105, as well as any passengers 106 that may be aboard. The automobile 100 (or simply “car” or “vehicle” herein) includes sensors mounted inside and/or outside the car. The internal-facing sensor 112, for example, may be mounted on the dash board, on the windshield or on some other portion of the car. The internal-facing sensor may be configured to driver or passenger movements, or determine which direction the driver is looking The sensor may include any device capable of sensing the location of objects. For example, the internal-facing sensor may include a color camera, depth camera, laser-based range finder, sonar-based range finder, or other position sensing device.

Similarly, the external-facing sensor 111 may include any type of movement or position sensing device including a color camera, depth camera, laser-based range finder, sonar-based range finder, or any combination of the above. The external-facing sensor 111 may be mounted within the car, or may be mounted on the grill or other outside surface of the car. The external-facing sensor is designed to locate or track objects around the car (in some cases, specifically those objects that are in front of the car). For example, the external-facing sensor may detect that a car, a person, an animal, a ball or other object is in the path of the car or is moving toward the car's line of travel. These objects may trigger an alarm within the vehicle, indicating to the driver that the driver should slow down, change lanes or otherwise take action to avoid the object.

In some embodiments, the internal-facing sensor and the external-facing sensory may work together to provide appropriate alerts to the driver 105. For instance, exterior sensor input 113 provided by the external-facing sensor 111 may be sent to an information processing system 110. Interior sensor input 114 may also be sent to the information processing system from the internal-facing sensor 112. The information processing system then uses the inputs to determine an appropriate action 116 to perform. For example, if the exterior sensor input 113 indicates that an alert is to be triggered (because, for example, a stationary object is rapidly approaching), the salience of the alert may be increased or decreased depending on where the driver is currently looking (as indicated by interior sensor input 114). If the driver is looking down the road, and appears not to be distracted, the alert may be subdued in some manner. Alternatively, if the driver is looking elsewhere (e.g. at passengers in the rear seat), the intensity of the alert may be raised such that the alert gets louder or is repeated.

Alerts may include audio, visual, or haptic notification provided by the automobile for the driver. The alerts may be initiated by the alerting system 115 which, at least in some cases, works in conjunction with the information processing system 110. Thus, alerts may include sounds such as beeps, spoken messages such as “Stop!” or other auditory cues. The alerts may also include visual warnings projected on a heads-up display, displayed on a navigation touchscreen, displayed on the dashboard or otherwise shown to the user. The alerts may also be touch-based such as a vibration in the seat, steering wheel or other location. Other alerts may also be used, and any combination of the above alerts may be used. When referring to the “salience” of an alert, a degree of relevance or intensity is intended. An increased level of salience in an alert would, for example, make the alert louder, more visible, or more tactile. Correspondingly, a decreased level of salience in an alert would, for example, make the alert quieter, less visible or less tactile.

Thus, in one embodiment, driver 105 may be operating the vehicle 101. The external-facing sensor 111 may detect that an object is about to enter the vehicle's path of travel. The internal-facing sensor may be monitoring the driver and any other vehicle occupants 106. If the internal-facing sensor determines that the driver is looking at the road and is paying attention other objects near the road (and even, potentially, the object detected by the external-facing sensor), any alerts triggered and initiated by the alerting system 115 may be subdued (i.e. the alert's salience is decreased). More specifically, the information processing system 110 may determine that the most appropriate action in this situation is to reduce the salience of any alerts that are triggered (or suppress the alerts entirely). This determined action 116 may be sent to the alerting system 115, which in turn reduces the salience of alerts that are triggered.

In some cases, a time window may be applied to any actions determined by the information processing system 110. For example, if the internal-facing sensor 112 determines that the driver is paying attention to driving at one point in time, the action to reduce the salience of any triggered alerts may only be valid for one or five or ten (or some other customizable number of) seconds. Similarly, if the internal-facing sensor determines that the driver is not paying attention, or that other vehicle occupants are being sufficiently distracting, the action to increase the salience of any triggered alerts may only be valid for a short amount of time. Once the information processing system has again determined that the driver is paying attention, the alerts may be again subdued or left at their normal level. Accordingly, the information processing system is continually determining the appropriate action to perform, based on input from both the internal-facing and the external-facing sensors.

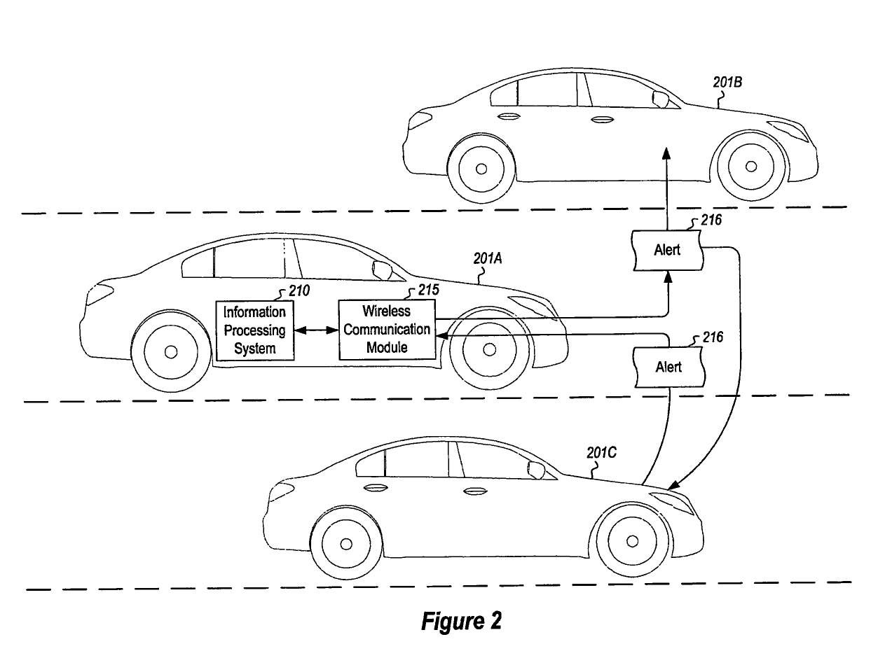

In some cases, as shown in FIG. 2, the determined appropriate action 116 is to transmit an alert to one or more neighboring automobiles. Automobile 201A is equipped with internal-facing and external-facing sensors (e.g. 112 and 111). These sensors provide interior and exterior input, as in FIG. 1. The information processing system 210 determines that, based on the exterior sensor input, an object (such as a vehicle) is in the car's line of travel. The information processing system may also determine that the driver is currently looking in another direction based on the interior sensor input. Accordingly, the information processing system may use wireless communication module 215 to send an alert 216 to either or both of vehicles 201B and 201C. As will be understood, the wireless communication module may be any type of communication system or device capable of transmitting data wirelessly. The wireless communication module may communicate these alerts 216 to other vehicles automatically when alerts are triggered. Wireless communication module 215 may also receive alerts from other automobiles.

As with the alerts above, the information processing system 210 may make a determination based on the exterior input from the external-facing sensor and the interior input from the internal-facing sensor. The determined action may be to suppress transmission of certain alerts to one or more neighboring automobiles. For example, if the driver appears to be paying attention to the road and to oncoming objects, the alert may be suppresses. If, however, the driver does not appear to be paying attention to oncoming objects (according to the internal-facing sensor), the alert may be sent, and in some cases, the salience for that alert may be increased. Similarly, alerts received from other cars may be played or suppressed according to the driver's recent actions. Still further, if the driver is determined to be paying some attention, but not direct attention, the alert may be played, displayed or otherwise initiated with a lower level of intensity.

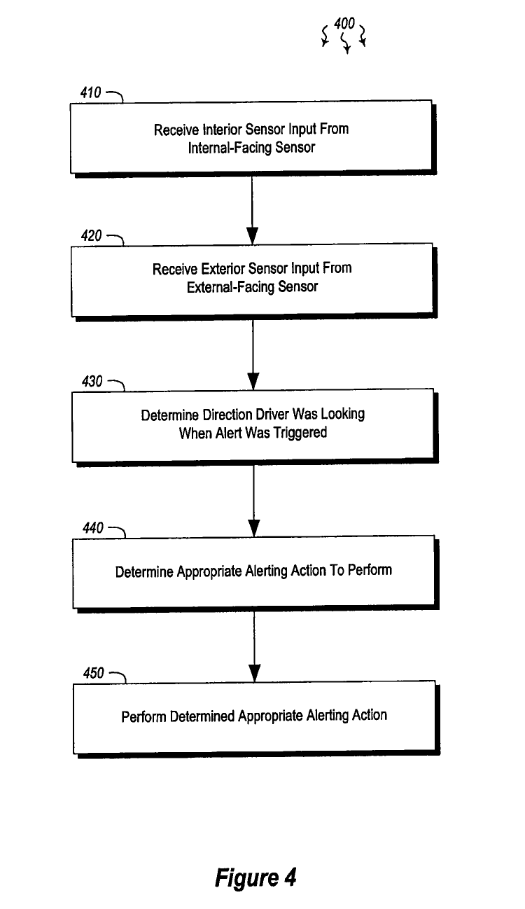

In view of the systems and architectures described above, methodologies that may be implemented in accordance with the disclosed subject matter will be better appreciated with reference to the flow chart of FIG. 4. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 4 illustrates a flowchart of a method 400 for providing appropriate automotive alerts. The method 400 will now be described with frequent reference to the components and data of environment 100 of FIG. 1.

Method 200 includes an act of receiving interior sensor input from at least one internal-facing sensor, the interior sensor input indicating information about the actions of one or more automobile occupants including a driver (act 210). As mentioned above, the information processing system 110 may receive interior sensor input 114 from internal-facing sensor 112. The interior sensor input provides information about the driver's current and past level of awareness. The internal-facing sensor may be able to determine the driver's body position, the direction the driver is looking, whether the driver checks his or her mirrors often, whether the driver is looking at occupants in the back seat, whether the driver is texting, talking on the phone or otherwise using a digital device, or may look at other indicators that the driver is or is not paying attention to driving.

Method 200 further includes an act of receiving exterior sensor input from at least one external-facing sensor, the exterior sensor input indicating information about one or more objects external to the automobile (act 220). External-facing sensor 111 is positioned to identify objects external to the car. When an object such as a car, a ball, an animal or other object is detected along (or near) the driver's current path of travel, the sensor's exterior input 113 may indicate to the information processing system that an alert is to be triggered. Then, based on both the received interior sensor input 114 and the received exterior sensor input 113, the information processing system may determine that the driver was looking in a specified direction when an object external to the automobile triggered an alert (act 230). If the information processing system determines that the driver was looking at the road, down the line of travel (or substantially near thereto), an appropriate action may be determined (act 240) and performed (act 250). In this example, the determined appropriate action 116 would be to decrease the salience of the alert or suppress it entirely. If, however, the driver appears distracted, the salience of the alert may be increased. In such cases, the alert may be louder and/or brighter and may be repeated multiple times (e.g. until the driver takes an appropriate action such as braking or swerving).

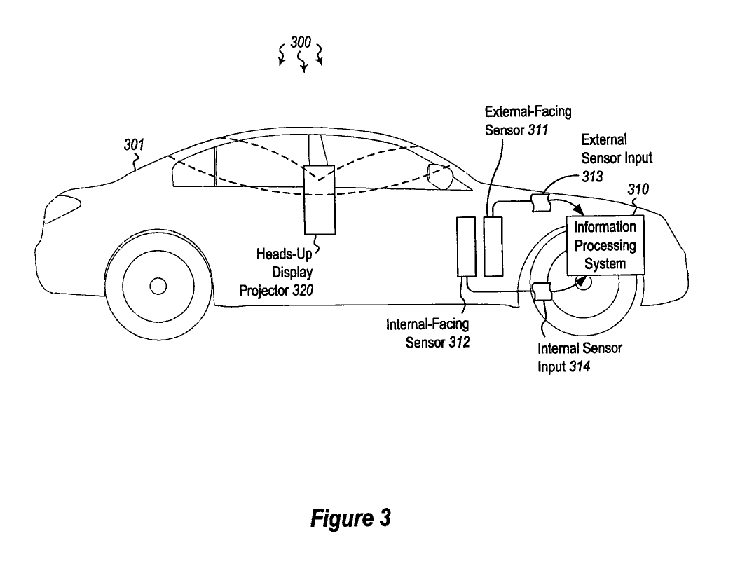

Turning now to FIG. 3, an automotive heads-up display projection system 300 is provided. The automotive heads-up display projection system includes at least one internal-facing sensor 312 positioned within an automobile 301 and at least one external-facing sensor 311 positioned within (or on the exterior of) the automobile. The system also includes at least one internal heads-up display projector 320 configured to project a heads-up display on one or more interior surfaces of the automobile. Although shown as being mounted in the middle of the car, the heads-up display projector may be mounted on the dashboard, on the windshield, on the interior side of the roof or on any other surface of the car.

The heads-up display may be configured to project annotations or images onto the dash, windshield, A-frame, B-pillar or any other portion of the automobile's interior. The annotations may include speed information, distance information, alerts, navigational information or substantially any other type of information capable of projection by a projector. The system also includes, as above, an information processing system 310 that receives sensor input from the internal-facing and external-facing sensors and, based on the input received from both sensors, makes a determination as to an appropriate action to take and performs that action. The interior sensor input 314 indicates information about the actions of one or more automobile occupants including a driver, while the exterior sensor input 313 indicates information about various objects that are external to the automobile

When annotations are projected onto the various interior surfaces of the automobile, the heads-up display projects the annotations onto the external objects detected by the external-facing sensor, so that those annotations appear to be co-located with those external objects from the driver's perspective. The internal-facing sensor can detect where the driver is currently looking and the heads-up display can project in that direction accordingly. Thus, if the user is looking out the driver-side window, the annotations can be projected onto the driver-side window. If the driver is looking through the right side of the windshield and near the A-frame, the heads-up projector may display the annotations on the windshield and/or on the opaque portion of the A-frame. In some cases, the projected heads-up display is continually adapted as the driver looks in different directions. Accordingly, as the driver moves his or her head to look in different directions, the heads-up display will correspondingly project the annotations in the direction the driver is looking, so that the annotations continually appear to be co-located with the corresponding external objects that are in that direction.

In some embodiments, the heads-up display projector may project an external view on the interior surfaces of the automobile where the external view is what the driver would see exterior to the automobile if the interior opaque surface were transparent. Thus, the external-facing sensor 311 may determine that a tree is to the front and right of the car. If the driver is looking at the right side of the windshield where the A-frame is positioned between the windshield and the passenger-side window, the information processing system may determine based on the exterior input that the tree to the front and right of the car would be in the driver's line of sight where the A-frame is in the car. Accordingly, the heads-up projector 320 may display a picture of the tree (received from the exterior sensor input 313) on the A-frame. This projection may be continually updated so that, as the car is moving, the images projected are continually updated. Moreover, the projector may continually change the interior surface it is projecting onto based on which direction the driver is looking (as determined by the interior sensor input 314). Thus, the driver can see a projected an external view of what he or she would see exterior to the automobile if the interior opaque surface (e.g. the A-frame) were transparent.

Accordingly, systems, methods and apparatuses are provided which determine internal and external circumstances and provide alerts to the driver accordingly. Moreover, systems, methods and apparatuses are described which provide an automobile driver a heads-up display projection system which provides the driver annotations projected onto the surfaces at which the driver is currently looking

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. An automotive system, comprising:
at least one internal-facing sensor positioned within an automobile;
at least one external-facing sensor positioned within the automobile;
an information processing system that performs the following:
receives interior sensor input from the at least one internal-facing sensor, the interior sensor input indicating information about the actions of one or more automobile occupants including a driver;
receives exterior sensor input from the at least one external-facing sensor, the exterior sensor input indicating information about one or more objects external to the automobile;
based on both the received interior sensor input and the received exterior sensor input, determines an appropriate action to perform; and
performs the determined appropriate action.

2. The automotive system of claim 1, wherein the determined appropriate action comprises increasing the salience of a triggered alert.

3. The automotive system of claim 1, wherein the determined appropriate action comprises decreasing the salience of the triggered alert.

4. The automotive system of claim 1, wherein the determined appropriate action comprises suppressing a triggered alert such that the triggered alert is not presented.

5. The automotive system of claim 1, wherein the determined appropriate action comprises transmitting one or more alerts to one or more neighboring automobiles.

6. The automotive system of claim 1, wherein the determined appropriate action comprises suppressing transmission of one or more alerts to one or more neighboring automobiles.

7. The automotive system of claim 1, wherein the determined appropriate action comprises receiving and playing an alert received from a neighboring automobile.

8. The automotive system of claim 1, wherein the determined appropriate action comprises receiving and suppressing an alert received from a neighboring automobile.

9. The automotive system of claim 1, wherein the determined appropriate action comprises projecting a heads-up display that includes annotations on one or more external objects, such that those annotations appear to be co-located with those external objects from the driver's perspective.

10. The automotive system of claim 9, wherein projecting a heads-up display comprises projecting an external view of what the driver would see exterior to the automobile if the interior opaque surface were transparent.

11. The automotive system of claim 9, wherein the heads-up display is projected onto those opaque surfaces at which the driver is currently looking

12. The automotive system of claim 11, wherein the heads-up display projection is dynamically updated as the driver changes perspective.

13. A method for providing appropriate automotive alerts, the method comprising:
receiving interior sensor input from at least one internal-facing sensor, the interior sensor input indicating information about the actions of one or more automobile occupants including a driver;
receiving exterior sensor input from at least one external-facing sensor, the exterior sensor input indicating information about one or more objects external to the automobile;
based on both the received interior sensor input and the received exterior sensor input, determining that the driver was looking in a specified direction when an object external to the automobile triggered an alert;
based on the direction the driver was looking and based on the location of the external object, determining an appropriate alerting action to perform; and
performing the determined appropriate alerting action.

14. The method of claim 13, wherein performing the determined appropriate alerting action comprises increasing the salience of the alert triggered by the external object.

15. The method of claim 13, wherein performing the determined appropriate alerting action comprises decreasing the salience of the alert triggered by the external object.

16. The method of claim 13, wherein the determined appropriate alerting action comprises suppressing the triggered alert such that the triggered alert is not presented to the driver.

17. An automotive heads-up display projection system, comprising:
at least one internal-facing sensor positioned within an automobile;
at least one external-facing sensor positioned within the automobile;
at least one internal heads-up display projector configured to project a heads-up display on one or more interior surfaces of the automobile;
an information processing system that performs the following:
receiving interior sensor input from the at least one internal-facing sensor, the interior sensor input indicating information about the actions of one or more automobile occupants including a driver;
receiving exterior sensor input from the at least one external-facing sensor, the exterior sensor input indicating information about one or more objects external to the automobile;
based on both the received interior sensor input and the received exterior sensor input, determining an appropriate action to perform; and
performing the determined appropriate action.

18. The automotive heads-up display projection system of claim 17, wherein projecting a heads-up display on one or more interior surfaces of the automobile comprises projecting a heads-up display that includes annotations on one or more external objects, such that those annotations appear to be co-located with those external objects from the driver's perspective.

19. The automotive heads-up display projection system of claim 17, wherein projecting a heads-up display on one or more interior surfaces of the automobile comprises projecting an external view of what the driver would see exterior to the automobile if the interior opaque surface were transparent.

20. The automotive heads-up display projection system of claim 17, wherein the projected heads-up display is continually adapted as the driver looks in different directions.
